(19) United States
(12) Patent Application Publication
(10) Pub. No.: US 2013/0179196 A1
(43) Pub. Date: Jul. 11, 2013

(54) SYSTEM AND METHOD FOR HEDGING RISKS WITHIN VARIABLE ANNUITY LIFE INSURANCE AND VARIABLE ANNUITY LIFE REINSURANCE PORTFOLIOS

(71) Applicant: Daniel Brookman, New York, NY (US)

(72) Inventor: Daniel Brookman, New York, NY (US)

(73) Assignee: Barclays Capital, Inc., New York, NY (US)

(21) Appl. No.: 13/567,426

(22) Filed: Aug. 6, 2012

Related U.S. Application Data
(60) Provisional application No. 61/515,737, filed on Aug. 5, 2011.
(60) Provisional application No. 61/616,290, filed on Mar. 27, 2012.

(51) Int. Cl. G06Q 40/08

(52) U.S. Cl. CPC G06Q 40/08
USPC 705/4

(57) ABSTRACT

A computer-based framework for assessing risks embedded within variable annuity portfolios and a structure for quantifying component risk elements, bifurcating such risks across one or more hedging counterparties and utilizing rating agency methodologies for achieving an implied financial strength rating of one or more entities within a transaction structure and/or issuer credit rating of risk-linked securities issued by the entities within the structure for risk mitigation purposes.

### RELATED APPLICATIONS

This application is a non-provisional application based on U.S. Provisional Application Ser. No. 61/515,737, filed Aug. 5, 2011, and U.S. Provisional Application Ser. No. 61/616,290, filed Mar. 27, 2012, the contents of which are incorporated herein by reference in their entirety.

### FIELD OF THE INVENTION

The present disclosure generally relates to systems and method for modeling risk and for determining hedging solutions associated with variable annuity exposures.

### SUMMARY OF THE INVENTION

Various exemplary embodiments of the present invention provide a computer-based framework for assessing risks embedded within variable annuity portfolios and a structure for quantifying component risk elements, bifurcating such risks across one or more hedging counterparties and utilizing rating agency methodologies for achieving an implied financial strength rating of one or more entities within a transaction structure and/or issuer credit rating of risk-linked securities issued by the entities within the structure for risk mitigation purposes.

A method according to an exemplary embodiment of the present invention comprises the steps of: 1) obtaining, by one or more computers, first data related to a book of business of a protection buyer that provides insurance to one or more policyholders under one or more corresponding policies; 2) determining, using one or more computers, second data related to projected market performance of underlying assets of the book of business; 3) determining, using one or more computers, hedging data related to hedging, by a reinsurer, of losses incurred by the protection buyer in providing the insurance; 4) modeling, using one or more computers, a plurality of scenarios, each of the plurality of modeled scenarios comprising a projected net asset value of the reinsurer at the end of a modeled projection period based on the first data, the second data and the hedging data, the modeled projection period being divided into a plurality of time periods, each of the plurality of scenarios taking as input for each of the one or more policies and for each of the plurality of time periods a first random number used to determine mortality risk of the policy and a second random number used to determine behavioral risk of the policy; 5) calculating, using the one or more computers, a percentage of the modeled scenarios that are default scenarios in which the projected net asset value of the reinsurer is negative; 6) determining, using one or more computers, an implied financial strength rating of the reinsurer based on the calculated percentage of default scenarios; 7) determining, using one or more computers, whether the implied financial strength rating of the reinsurer satisfies a required financial strength rating; 8) if the financial strength rating of the reinsurer satisfies the required financial strength rating, determining, using one or more computers, a maximum number of the default scenarios that results in the required financial strength rating; 9) selecting, using one or more computers, a first set of the default scenarios, the first set of the default scenarios satisfying the following criteria: i) the number of default scenarios in the first set is the maximum number of default scenarios; and ii) the default scenarios in the first set have projected net asset values that are the least negative of all the default scenarios; 10) providing, using one or more computers, reinsurance to the protection buyer in an amount that is capped based on the first set of default scenarios.

In an exemplary embodiment, the insurance provided by the protection buyer is a variable annuity-based insurance.

In an exemplary embodiment, the insurance provided by the protection buyer is a Guaranteed Minimum Death Benefit.

In an exemplary embodiment, the reinsurer is a Special Purpose Reinsurance Vehicle.

In an exemplary embodiment, the provided reinsurance is capped using a target cap.

In an exemplary embodiment, the method further comprises the step of funding the reinsurer using premiums paid by the protection buyer.

In an exemplary embodiment, the step of determining hedging data comprises determining at least one of market hedging data or actuarial hedging data.

In an exemplary embodiment, the first data relates to information pertaining to each of the one or more policyholders.

In an exemplary embodiment, the information comprises one or more of the following types of information: policy number, product identifier, policy issuance date, policyholder age at date of policy issuance, policy term, gender of policyholder, premium paid per policy, details relating to guarantees provided to the policyholder, allocations made by policyholder into one or more investment funds, current account value of allocations made to the investment funds, details of all charges charged to the policyholder upfront and/or during the tenor of the policy, and details of investment funds available to policyholders.

In an exemplary embodiment, the step of modeling comprises identifying credits as one or more of the following: premiums received upfront and/or over time by the reinsurer from the protection buyer, payouts received by the reinsurer from the determined hedging data over time, and base capital invested into the reinsurer.

In an exemplary embodiment, the step of modeling comprises identifying debits as one or more of the following: hedging payments, operating costs, payments of losses under a reinsurance contract entered into by the reinsurer with the protection buyer, and payment of arranger fees.

In an exemplary embodiment, the second data is calculated using an option pricing model.

In an exemplary embodiment, the option pricing model is a Black-Scholes pricing model or a modified variant thereof.

In an exemplary embodiment, the option pricing model is a Binomial options pricing model or a modified variant thereof.

In an exemplary embodiment, the hedging data is determined using put options and/or other OTC derivative contracts as the hedge.

In an exemplary embodiment, the hedging data is determined using a proxy hedge.

These and other features of this invention are described in, or are apparent from, the following detailed description of various exemplary embodiments of this invention.

### BRIEF DESCRIPTION OF THE DRAWINGS

The features and advantages of the present invention will be more fully understood with reference to the following, detailed description of illustrative embodiments of the present invention when taken in conjunction with the accompanying figures, wherein:

FIG. 1 is a block diagram showing a system for providing reinsurance according to an exemplary embodiment of the present invention;

FIG. 2 shows a flowchart illustrating a method of providing collateralized reinsurance according to an exemplary embodiment of the present invention;

FIG. 3 shows a sample portfolio of a Protection Buyer, including a subject risk portfolio, underwriting guidelines, market risk components and actuarial risk components;

FIG. 4 shows exemplary charts that may be generated by an SPRV as part of the scenario modeling used to formulate hedges to counter the risk associated with the Protection Buyer's variable annuity portfolio according to an exemplary embodiment of the present invention;

FIG. 5 shows another exemplary chart that may be generated by the SPRV as part of the scenario modeling according to an exemplary embodiment of the present invention;

FIG. 6 shows an exemplary chart demonstrating a particular scenario in which the SPRV may have insufficient capital to meet its obligations under the Reinsurance Contract;

FIG. 7 shows a chart of aggregate “true-up” of credits and debits for an exemplary transaction between the Protection Buyer and the reinsurer according to an exemplary embodiment of the present invention;

FIG. 8 is a table showing an example of a single path outcome for a single policy according to an exemplary embodiment of the present invention; and

FIG. 9 provides the steps involved with carrying out a method of stochastic modeling of a transaction between a Protection Buyer and reinsurer according to an exemplary embodiment of the present invention.

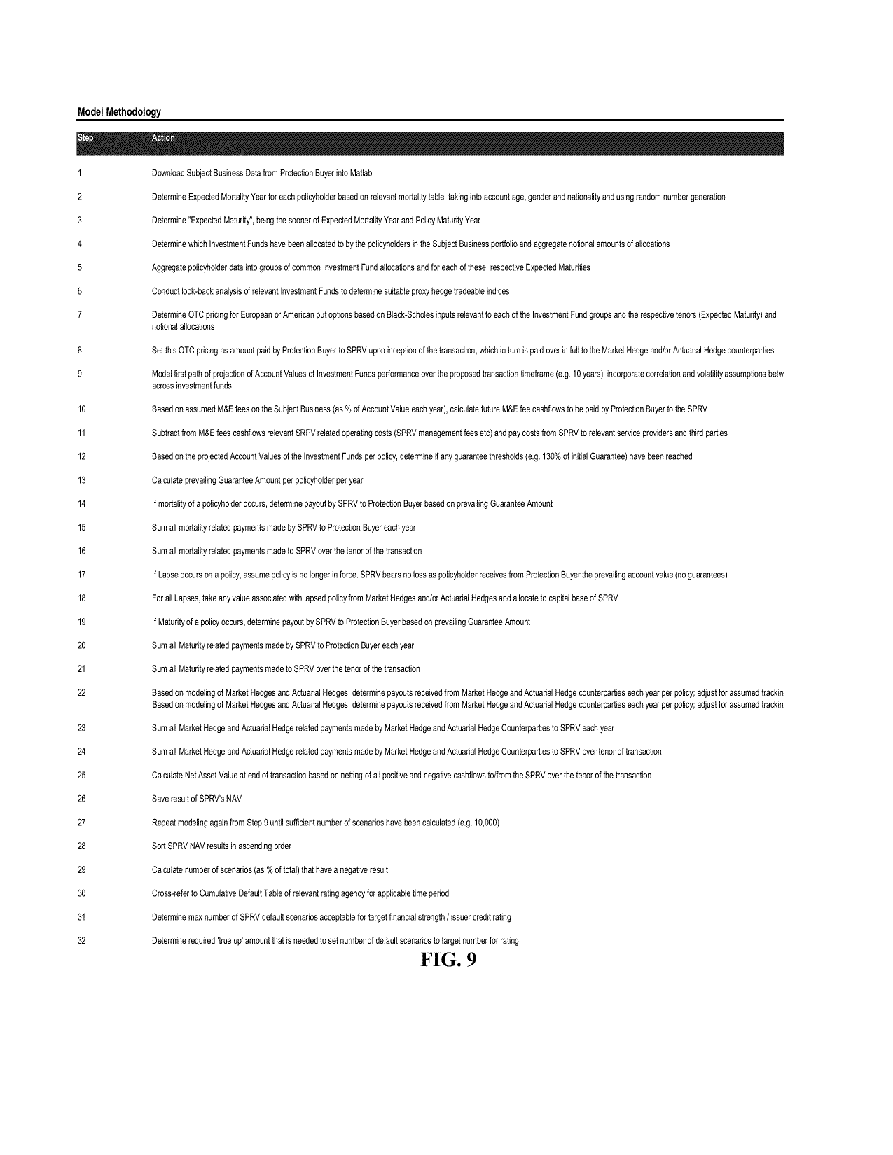

### DETAILED DESCRIPTION OF EMBODIMENTS OF THE PRESENT INVENTION

Various exemplary embodiments of the present invention provide a collateralized reinsurance-based solution to life insurance providers that offer their customers investment-related guarantees via variable annuity contracts. For ease of explanation, a life insurance provider that purchases reinsurance according to the various exemplary embodiment of the present invention is referred to herein as the “Protection Buyer”. In exemplary embodiments, the “Protection Buyer” may also refer to a reinsurer that purchases reinsurance. The inventive systems and methods may be used to quantify and hedge risks such as, for example, embedded market risks, mortality risks and behavior risks associated with products such as, for example, Guaranteed Minimum Death Benefits (“GMDB”) or other types of variable annuity-based products offered by the Protection Buyer. According to various exemplary embodiment of the present invention, a stochastic model is generated based on data provided by the Protection Buyer that can be used to establish an actual or implied financial strength rating for the reinsurer. The rating may be used as leverage so that all modeled loss scenarios do not need to be covered under the hedging scheme, leaving extreme tail risk to be retained by the Protection Buyer. This extreme tail risk can be quantified by the Protection Buyer and they can calculate an appropriate level of capital to hold against such extreme tail risk. In embodiments, this invention provides the Protection Buyer with capital relief (because the protection is offered in reinsurance form) and enables the Protection Buyer to reduce the cost of hedging such a portfolio as well as potentially participate in some or all of the future economics of the reinsurer used for the purpose of hedging.

There is currently an over the counter (“OTC”) market for insurance-linked and event-linked securities. As this market has evolved over time, Protection Buyers have generally preferred to execute risk transfer solutions via special purpose reinsurance vehicles (“SPRV”s) established on a per client, per deal basis rather than via less transparent bank-owned or bank-affiliated transformer reinsurance companies where legacy, unrelated exposures could potentially adversely impact a Protection Buyer's ability to make claim collections from such an entity. Thus, in various exemplary embodiments of the present invention, an SPRV licensed to conduct a life reinsurance business may be established or a ‘fronting’ reinsurance vehicle including a bank-owned transformer may be used to effect the transaction. The SPRV may be established by a bank or other financial entity, and the SPRV may be owned by a charitable trust or some other trust structure but not by the originating bank or financial entity. In an exemplary embodiment, the SPRV has no prior trading history or exposure and is established in a domicile having an established regulatory regime such as, for example, Bermuda, Ireland, Cayman Islands, Holland, Guernsey, Isle of Man, Switzerland, Gibraltar, Luxembourg and Singapore, to name a few. In general, a location selected for establishment of the SPRV preferably has a regulatory agency that provides a license to be a reinsurance company and provides capital relief to hedge the risk using derivatives or to collateralize the risk using derivatives. The SPRV is able to provide transaction transparency, cost savings, execution in a familiar territory with an established and recognized regulatory framework, and a favorable capital treatment for the transaction.

According to an exemplary embodiment, the SPRV may enter into a quota share reinsurance contract (the “Reinsurance Contract”) with the Protection Buyer referencing an in-force (existing) or pro forma (future) book of variable annuity business (the “Subject Business”) that the Protection Buyer has underwritten in the past or intends to underwrite in the future. Under the Reinsurance Contract, the SPRV may assume all risks associated with the Subject Business including but not limited to embedded market risks, mortality risks and behavior risks.

The claims paying capacity of the SPRV may be provided by one or a combination of some or all of (i) paid up equity capital (or equivalent), (ii) assets in the form of OTC or exchange-traded derivative contracts (“market hedges”) with one or more counterparties, and (iii) assets in the form of derivatives, securitization products or reinsurance contracts with one or more third parties for the hedging of mortality risks and/or behavior risks (“actuarial hedges”). Premiums paid either upfront, or over time, by the Protection Buyer may be used to fund some or all of the cost of capitalizing the SPRV, including the cost of purchasing market hedges and/or actuarial hedges. Certain ongoing fees (“M&E Fees”) may be paid upfront or each year (often as a percentage of prevailing account values per underlying policyholder) from the Protection Buyer to the SPRV. Such amounts may be retained by the SPRV to augment its claims-paying capacity. In an exemplary embodiment, subject to negotiation on a case by case basis and in accordance with local risk transfer requirements, the Protection Buyer may be entitled to a participation in some or all of the profits (the “Profit Share”) of the SPRV at the maturity of the transaction.

In accordance with embodiments of the present invention, M&E fees, premiums and/or profit shares may be calculated using the modeling system disclosed herein. In this regard, in various exemplary embodiments, the SPRV may provide hedging solutions that address the risk that is directly or indirectly associated with the Protection Buyer's book of business. For example, the Protection Buyer's funds may indirectly track a stock index, such as, for example, the S&P 500, and the hedging solutions may track the S&P 500 to hedge the Protection Buyer's projected losses. The modeling scheme disclosed herein may take as input the hedging solutions and assumptions regarding mortality risk, behavioral risk and market risk, and calculate a percentage of modeled scenarios in which the SPRV's net asset value has a negative value (i.e., there is a projected default scenario). The calculated percentage may be cross-referenced with a reference default table, such as, for example, a cumulative default table of a relevant rating agency or a default table generated by the SPRV, to determine the maximum number of SPRV default scenarios that are acceptable for an implied target financial strength rating of the reinsurer. Of the default scenarios, only the least negative may be selected to make up the maximum number of default scenarios to be covered by the reinsurer, with the protection buyer covering the risk for the remaining most negative and least likely to occur default scenarios. Collateralized reinsurance may then be offered to the protection buyer with a cap calculated based on the selected maximum number of default scenarios. In exemplary embodiments, the calculated cap may be a “target cap” that sets the limit of liability of the SPRV but does not require the SPRV to cover all losses up to that limit or pay more than that limit in the event of excess profits. In an exemplary embodiment, a calculation can be made for the “true-up” amount required to set the number of default scenarios to achieve the actual or implied target financial strength rating. The present value of the “true-up” amount may be calculated and added to the up front hedging premium cost for the protection buyer.

According to various exemplary embodiments of the present invention, the Protection Buyer may provide data on the Subject Business. This data, which may be stored in a database of a computer system made up of one or more computers, may include information relating to each of the Protection Buyer's policyholders (usually individuals) including but not limited to: Policy Number, Product Code or Identifier, Policy Issuance Date, Policyholder Age at Date of Policy Issuance, Policy Term, Gender of Policyholder, Premium Paid Per Policy, Details Relating to Guarantees Provided to the Policyholder, Allocations Made by Policyholder (or others on their behalf) into one or more Investment Funds, Current Account Value of Allocations to the Investment Funds, Details of All Charges (such as Front Load Fees, ongoing fees (e.g. M&E Fees) etc) charged to the Policyholder upfront and/or during the tenor of the policy, and Details of Investment Funds available to Policyholders (including Fund Manager, Benchmark Index, Historic Track Record etc).

The Protection Buyer may also provide additional information, which may be stored in the same or different database of the same or different computer system made up of one or more computers, including, but not limited to reports prepared internally or externally regarding the historic and/or projected performance of the Subject Business (specifically relating to key information such as lapse assumptions and mortality rates). Furthermore, the Protection Buyer may provide, or the transaction arranger or SPRV may obtain, benchmark mortality tables which can be stored on the same or different database on the same or different computer system relevant to the policyholders of the Subject Business.

Various exemplary embodiments of the present invention are implemented through the use of one or more computers, where such computers may include, among other components, a memory, one or more processors and computer readable media that include computer-readable code that instruct the processor to carry out various steps of the invention. In this regard, one or more computers are used to collect and store the data from the Protection Buyer and, as discussed in further detail below, generate a model of the SPRV claims paying capacity using the collected data. The computer-generated model may be constructed to determine the range of modeled outcomes of the net asset value or implied financial strength of the SPRV over the tenor of the proposed transaction. The computer-generated model may be stochastic to enable a distribution of outcomes to be computed. These scenarios may be designed to provide an illustration of many potential outcomes based on modeled differences in performance of the underling investments funds, the modeled differences in the performance of the Market Hedges and the Actuarial Hedges entered into by the SPRV, modeled differences in the mortality experience of the lives of the policyholders in the Subject Business and the differences in behavior of the policyholders referenced in the Subject Business (e.g. lapsing of policies).

In embodiments, the model as implemented on one or more computers may take as credits to the SPRV the following: Premiums received upfront and/or over time by the SPRV from the Protection Buyer, Payouts received by the SPRV from the Market Hedges and/or Actuarial Hedges over time, and base capital invested into the SPRV. In embodiments, the model as implemented on the one or more computers may take as debits from the SPRV the following: Payment of premiums or coupons, as applicable for any/all Market Hedges and/or Actuarial Hedges either upfront or over time, Payments of SPRV-related costs including but not limited to SPRV Manager fees (if applicable), regulatory and licensing fees and any other operational costs that may be expected to arise from time to time, Payments of losses under the collateralized Reinsurance Contract for claims relating to the Subject Business, and Payments of arranger fees to service providers, including founders/sponsors/arrangers of SPRV and the Transaction generally.

Market Returns of the Investment Funds (the “Account Value”) may be calculated using the one or more computers. In this regard, the projected returns of the investment funds may be calculated on a per period basis (monthly, quarterly, annually, as applicable) using an option pricing model, such as, for example, a Lognormal process or equivalent. Many paths (e.g., 1,000 or more) may be generated for the Market Returns. Where applicable, correlation assumptions may be used to capture correlation between investment funds.

The one or more computers may be used to calculate the performance of the Market Hedges. In this regard, a form of market proxy hedge may be determined (if it is not possible to trade in the underlying investment funds themselves) based on back-testing of historic performance of the referenced investment funds against the proxy hedge. An assumption may be made about the effectiveness of such a hedge, taking into account the potential for positive or negative basis risk in using a proxy hedge. The Market Hedges may be European or American put options. The Market Hedges may be calculated and structured based on certain tenor assumptions per policyholder derived from the expected tenor of the policyholder's policy (that is, minimum of life expectancy, assumed time to lapse or time to maturity of the policy namely “Expected Maturity”). The proxy hedges may be calculated based on aggregate notional amounts of guarantees across policyholders with common Expected Maturity (e.g. 5 years), taking into account split of investment allocations across underlying investment funds.

In an exemplary embodiment of the invention, the potential for policyholders to lapse may not be considered when determining the notional amounts to be hedged under the proxy hedges. In this way, the SPRV may ‘over-hedge’ in terms of ultimate notional of guarantees to the extent that any lapses occur in the Subject Business. This assumes that upon lapse, no payment would be due from the SPRV to the Protection Buyer. In some instances, a ‘penalty’ may be due from the lapsing policyholder that may be passed through to the SPRV by the Protection Buyer. In such situations, any payments to the SPRV from Market Hedges or Actuarial Hedges relating to the lapsed policies would accrue within the SPRV and augment the SPRV's ability to meet other claims payments, if needed.

In embodiments, to the extent that the Subject Business includes ratchet features (that is, where the guarantee due to the policyholder can increase beyond the initial guarantee amount if the value of the underlying investments reaches or exceeds certain threshold levels, e.g. 130% of initial guarantee), then the modeled payout upon the mortality or maturity of the underlying policyholder may be the higher of (i) the prevailing investment fund value at the time of mortality or maturity and (ii) the highest historic threshold level reached over the tenor of the policy.

In embodiments, the modeled paths of the performance of the investment funds referenced under the policies within the Subject Business may be determined on a per fund basis, taking into account the aggregate notional amount of all allocations to each of the respective funds. Similarly, the value and performance of the proxy hedges may be calculated on a similar aggregate basis. Once calculated, the proportionate share of the projected account values and the projected values of the proxy hedges may be offset against each other and allocated on a per policyholder basis when a mortality is modeled to occur. The model may be constructed such as on a per policyholder basis, mortality, lapse and maturity can only occur once and mortality is be assumed to occur before any lapse or maturity where such policyholder mortality is projected to occur in the same year as a projected lapse or maturity. Upon a mortality or a maturity event per policy, the net resulting liability, if any to the SPRV under the Reinsurance Contract per policyholder may be determined. The residual value, if any, per year within the SPRV may be totaled over the projected tenor of the transaction to arrive at a net asset value (“NAV”) of the SPRV at the scheduled end of the Reinsurance Contract. Due to the stochastic modeling of the transaction, a distribution of NAVs may be calculated.

To the extent required by the Protection Buyer, the arrangers or sponsors of the transaction may engage one or more rating agencies to assess the transaction structure and projected economics to determine a public or private financial strength rating of the SPRV (and if applicable, issuer credit rating of securities it may issue to hedge Market Risks and/or Actuarial Risks). Drawing on the established methodologies of the respective rating agencies for rating of insurance companies as well as insurance-linked securities transactions, attention may be given to the distribution of NAVs of the SPRV over a specified time period, as well as the structural features and protections embedded in the transaction documentation and any relevant credit risks. A third party actuarial or modeling firm may be engaged to assess or validate the assumptions used for Market Hedges and Actuarial Hedges. Stress tests on the assumptions may be performed to see how sensitive the NAV distributions are to such stress tests.

Through executing this structure, a Protection Buyer may enter into a partial or total collateralized reinsurance solution for the Subject Business of their variable annuity related risks, thereby achieving partial or total capital relief and acceptable accounting treatment for the hedging solution. The Protection Buyer can face a rated entity and can have full transparency of the Market Hedges and Actuarial Hedges that the SPRV may have entered into and the terms of those hedges. Through the transaction structure, the SPRV would be able to hedge less than the notional amount of the embedded guarantees via the Market Hedges and Actuarial Hedges, resulting in an important present value cost saving for the Protection Buyer. Of the modeled scenarios, there would likely be a small number of modeled scenarios where the financial means of the SPRV may be insufficient to cover the total modeled future claims made upon the SPRV in those scenarios. Such extreme tail basis risk can be understood and quantified by the Protection Buyer, against which a capital charge, if applicable, could be calculated by such Protection Buyer which is expected to be substantially lower than the prevailing capital charge for the entire Subject Portfolio prior to execution of the transaction.

In the vast majority of modeled scenarios, the SPRV would generate a positive NAV at the maturity date of the Reinsurance Contract. Subject to negotiation with the SPRV, the Protection Buyer may be entitled to some of such positive amounts, equating to a future claw-back or profit share in the cost of hedging the portfolio and enabling the Protection Buyer to participate in any upside of the SPRV, making for a compelling solution versus existing solutions and structures offered by traditional reinsurers, banks and/or bank-affiliated transformer reinsurance vehicles.

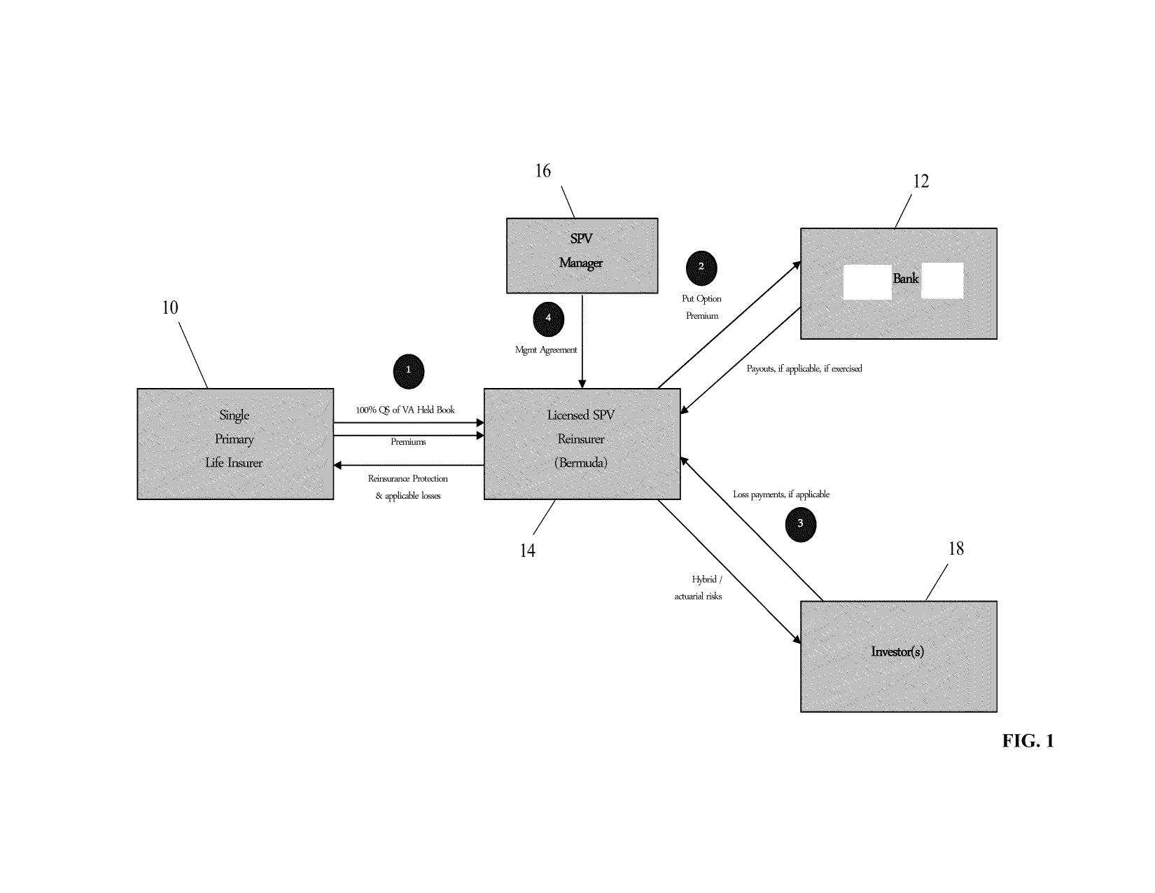

FIG. 1 is a block diagram showing a computer-based system, generally designed by reference number 1, for providing reinsurance according to an exemplary embodiment of the present invention. The system 1 includes a primary life insurer computer system 10 (Protection Buyer), a bank or other financial entity computer system 12, an SPRV computer system 14, an optional SPRV Manager computer system 16 and optional one or more investor computer systems 18. As discussed previously, the financial entity associated with the financial entity computer system 12 may establish the SPRV associated with the SPRV computer system 14 and place the SPRV under the care of an SPRV Manager associated with the SPRV Manager computer system 16. The SPRV Manager may be licensed to manage or conduct a reinsurance business and paid a fee to manage the SPRV and interface with regulators. The primary life insurer associated with the primary life insurance computer system 10 may provide up to 100% quota share of the variable annuity held book and negotiated premiums to the SPRV, and in return the SPRV may provide reinsurance protection. The liability under the quota share reinsurance contract may be capped at the value of the assets of the SPRV, where such assets include OTC derivatives with the financial entity and a reinsurance contract and/or mortality swap with third party investors associated with the third party investors computer systems 18. The SPRV may purchase using the SPRV computer system 14 derivatives, such as one or more OTC put options referencing a replication index, that attempts to replicate the performance of the underlying investment portfolio within the variable annuity portfolio to thereby form a hedging mechanism. In exemplary embodiments, the SPRV may look to other types of hedging solutions, such as, for example, securitized assets (e.g., ETFs, ETNs, etc.).

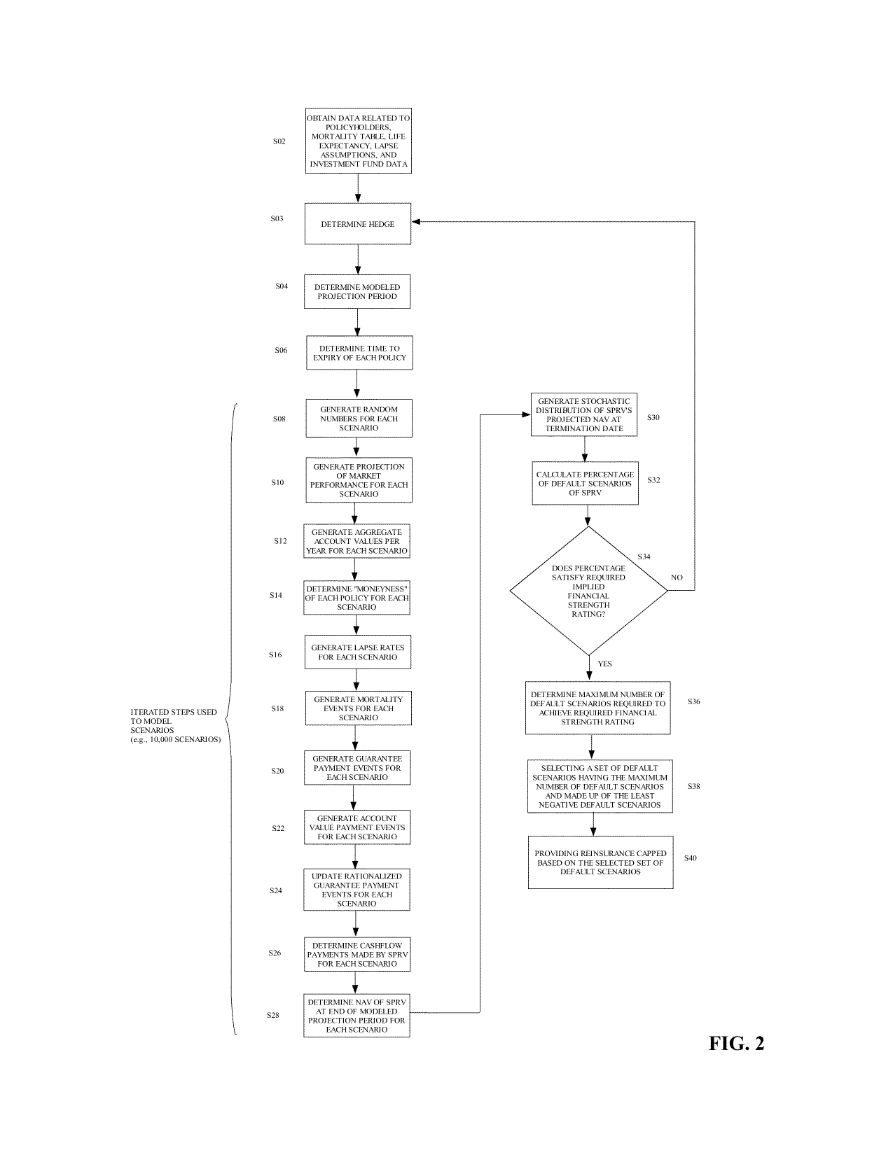

FIG. 2 is a flowchart showing a method, generally designated by reference number 100, for providing collateralized reinsurance intended to cover a book of business of a protection buyer. In exemplary embodiments, the method 100 may be performed by, for example, the SPRV computer system 14 or the financial entity computer system 12. Reference will be made to logic used in the various steps of the disclosed method (e.g., the placement of “1” or “0” at specific times within the modeled projection period to indicate modeled events, such as lapse of a policy). It should be appreciated that such logic is merely exemplary, and any suitable method may be used to track the occurrence of modeled events.

In step S02 of the method 100, various types of data are collected for use in the modeled scenarios. Such data may include, for example, seriatim data per policyholder, applicable mortality table data, life expectancy data, lapse assumptions, and per policy investment fund data (e.g., allocations made by policyholder to a variety of eligible investment funds), to name a few. The seriatim data per policyholder may be obtained by, for example, downloading the data from the protection buyer's proprietary database. The policyholder data may include, for example, policy number, product code or identifier, policy issuance date, policyholder age at date of policy issuance, policy term, gender of policyholder, premium paid per policy, details relating to guarantees provided to the policyholder, allocations made by policyholder (or others on their behalf) into one or more investment funds, current account value of allocations to the investment funds, details of all charges (such as front load fees, ongoing fees (e.g. M&E Fees) etc) charged to the policyholder upfront and/or during the tenor of the policy, and details of investment funds available to policyholders (including fund manager, benchmark index, historic track record, etc.). The lapse assumptions may also be obtained from the protection buyer, and in an exemplary embodiment the assumed relationship between policy status (In The Money (ITM) or Out of the Money (OTM)) may be linked to an assumed rate of lapse.

In step S03, the hedging assumptions and the structure and tenor of the derivative hedging solutions are determined. In an exemplary embodiment, in this step, the computer system performing the method 100 may sort the policyholder data obtained in step S02 according to expected maturity, where the expected maturity may be calculated as the lesser of (i) years until scheduled maturity and (ii) life expectancy from the reference mortality table. Per expected maturity, the aggregate value of prevailing guarantees across all policies may be calculated by, for example, the protection buyer computer system and provided to the reinsurer computer system. In an exemplary embodiment, the aggregate value of prevailing guarantees may be calculated by looking back to determine the higher of (i) the initial single premium amount and (ii) the highest previous ratchet or step up value reached by the account value over the policy in force in prior years. To determine the parameters of the hedging positions, which may be, for example, OTC European put option derivatives, the following assumptions may be used: 1) tenor equals the applicable expected maturity; 2) the reference index equals the benchmark index of each respective fund as provided in the policyholder data; and 3) strike equals the prevailing aggregate guarantee amount by expected maturity calculated using a projected market path for the underlying funds. The hedging assumptions may include an assumption of a certain amount of basis risk, such as, for example, a negative basis risk due to tracking error.

In step S04 of the method 100, a modeled projection period is determined. The modeled projection period may be, for example, a number of years, and may be determined as being the longest period of time until the last scheduled annuitization date of any/all of the underlying policies within the in force variable annuity portfolio.

In step S06 of the method 100, the Time to Expiry (TTE) of each policy is determined by overlaying the life expectancy assumptions on the policyholder data. In an exemplary embodiment, “expiry” may mean the earlier of (i) predicted mortality based on age and gender, and (ii) scheduled annuitization date of the policy. In this regard, the computer system performing the method 100 may, for each policy, based on gender and current age of the policyholder, lookup the applicable mortality rate from the mortality table obtained in step 1 for each future year of the modeled projection period, resulting in the generation of a Mortality Rate Table. For each policy, based on the scheduled annuitization date, using a lookup function, the computer system may insert a “1” in the Nth year of the projection period corresponding to years left until the scheduled annuitization date, and insert “0” for all other years, resulting in a Maturity Event Table.

In step S08 of the method 100, random numbers may be generated for the stochastic modeling. In this regard, the generated random numbers may be used to model mortality and lapse occurrences within the modeled projection period. In an exemplary embodiment, random numbers may be generated per policyholder for each year of the projection period in two tables. One of the tables may be referenced as “Mortality Random Number Table” and the other table may be referenced as “Lapse Random Number Table”.

In step S10 of the method 100, projected market performance is generated over the projected modeled period for each underlying fund comprising each policyholder's account value. In an exemplary embodiment, in this step, assumption and other types of data per reference investment fund per policyholder may be used to generate projected market performance. Such data may include, for example, current account value, implied volatility, projected annualized return, fund management fees and M&E expenses per year calculated based on account value from time to time. Using the data, the projected value of each investment fund for each year of the projection period may be calculated. Projected value of each investment fund may be calculated using any suitable method, such as, for example, a Lognormal function or equivalent. The projected values may be tabulated in a Fund Projection Table.

In step S12 of the method 100, projected aggregate account values per year may be calculated by summing up the per year values per policyholder from the Fund Projection Table. The aggregate account values may be tabulated in an Aggregate Account Value Projection Table.

In step S14 of the method 100, the “moneyness” of each policy per year of the modeled projection period is determined. In an exemplary embodiment, in this step, for each policyholder in each year, a determination may be made of the highest value of (i) the initial single premium amount, and (ii) the highest previous ratchet or step up value reached by the account value over the policy in force period in prior years. This value may be tabulated in a Prevailing Guarantee Value Table. Then, for each policy for each year, the moneyness ratio may be determined by dividing the current account value per policy by the Prevailing Guarantee Value per policy. The moneyness ratios may be expressed as percentages and tabulated in a Moneyness Ratio Table.

In step S16 of the method 100, potential lapse events are modeled for each policyholder over the modeled projection period. In an exemplary embodiment , in this step, the computer system performing the method 100 may, for each policyholder in each projection year, lookup applicable lapse rates based on the corresponding prevailing Moneyness Ratio within the Moneyness Ratio Table, and tabulate the lapse rates in a Lapse Rate Table. A Lapse Event Table may then be generated by assigning a value of “1” to each policy for each year where the relevant Lapse Random Number Table value per policy per year is less that or equal to the corresponding Lapse Rate Table value per policy in such projected year. The Lapse Event Table may then be rationalized by maintaining the first to occur value of “1” per policyholder and replacing all future occurrences per policyholder, if any, with a value of “0”.

In step S18, potential mortality events are modeled for each policyholder over the modeled projection period. In an exemplary embodiment, in this step, the computer system performing the method 100 may, per policy and per projection year, insert into a Mortality Event Table the value of “1” if the values in the Mortality Random Number Table are less than or equal to the corresponding values in the Mortality Rate Table, and insert a value of “0” otherwise. The Mortality Event Table may then be rationalized by maintaining on a per policy basis the first to occur value of “1” within the projection period, if any, and replacing any and all subsequent occurrences with the value of “0”.

In step S20, potential guarantee payment events are modeled for each policyholder over the modeled projection period based on the modeled mortality events (step S18) and the projected maturity events (step S06). This modeling step takes into account situations where guarantee payments are due as a result of death of the policyholder or maturity of the policy. In an exemplary embodiment, in this step, the computer system performing the method 100 may, per policy and per year, insert the value of “1” where a value of “1” for either the rationalized Mortality Event Table or the Maturity Event Table occurs, and inset a value of “0” otherwise. The results may be tabulated in a Guarantee Payment Event Table. The Guarantee Payment Event Table may then be rationalized by maintaining on a per policy basis the first to occur value of “1” within the projection period, if any, and replacing any and all subsequent occurrences with the value of “0”.

In step S22, potential account value payments are modeled for each policyholder over the modeled projection period based on the modeled lapse events (step S16) and modeled guarantee payment events (step S20). This modeling step takes into account situations in which the account value is due for payment as a result of policy lapse. In an exemplary embodiment, in this step, per policy and per year, the computer system performing the method 100 may insert a value of “1” if the corresponding value in the Lapse Event Table is “1” and no prior year or current year value within the rationalized Guarantee Payment Event Table equals “1”. The results may be tabulated in an Account Value Payment Event Table.

In step S24, the modeled guarantee payment events are updated based on the modeled lapse events (step S16). This modeling step takes into account situations in which the policy has lapsed before the guarantee payment on the policy becomes due. In an exemplary embodiment, in this step, per policy and per year, if the corresponding value in the Lapse Event Table equals “1” in a projected year prior to the first occurrence, if any, of a value of “1” in the rationalized Guarantee Payment Event Table, all occurrences of a value of “1” in the rationalized Guarantee Payment Event Table are replaced with a value of “0”. The results may be tabulated in an Updated Guarantee Payment Event Table. For logical purposes, on the basis that any and all policies which do not experience a mortality event or a lapse event during the projection period, any such policy must have a value of “1” inserted in the Updated Guarantee Payment Event Table in the future year in which such policy is scheduled to amortize.

In step S26, cashflow payments to be made by the SPRV are modeled based on the modeled guarantee payment events (step S24), the modeled prevailing guarantees (step S14), and the modeled aggregate account values (step S12). This modeling step projects payments to be made by the SPRV in situations where a guarantee payment even occurs (e.g., the policyholder dies or the policy matures), and calculates such payments by subtracting the account value per policy from the prevailing guarantee of the policy. In an exemplary embodiment, in this step, for each policy in each year, the computer system performing the method 100 may calculate the difference between the corresponding value in the Prevailing Guarantee Table and the projected account value per policy if the former is larger than the latter and only where a value of “1” appears in the corresponding location in the Updated Guarantee Payment Event Table.

In step S28, the net asset value of the SPRV at the end of the modeled projection period for each modeled scenario is calculated. This step may be performed by calculating the positive (inwards) and negative (outwards) cashflows relating to the SPRV over the projection period. In this regard, the positive cashflows may be, for example, reinsurance or retrocession premiums (paid upfront and/or over time), receipt of M&E fees upfront and/or over time, interest income on cash balances (if any), investment income on assets (if any), and cash payments, if any, received under the hedging positions, to name a few. The negative cashflows may be, for example, hedging positions put premiums paid upfront or over time, incurred loss payments arising under the inwards reinsurance contract entered into between the ceding (re)insurer and the SPRV, interest expense (if any), structuring fees (if any), regulatory fees (if any), taxes (if any), and profit commission (if any), and if applicable, paid to the ceding insurer.

In step S30, a stochastic distribution of the SPRV's projected NAV at the end of the projected modeled period may be generated. In this regard, any suitable number of simulations may be performed, such as, for example, 10,000 simulations to arrive at 10,000 different scenarios having corresponding projected NAV values. As should be clear from the above description of the modeling steps, under each simulation, the underlying assumptions for market risk, lapse risk and mortality risk remain constant, with differences in outcome being generated on account of the lognormal projections of market performance and the application of a random number generator on the various drivers of the ultimate NAV of the SPRV.

In step S32, a percentage of scenarios in which the SPRV is in default is calculated. In this step, the SPRV NAV values may be sorted in ascending order, from the highest value to the lowest value. The number of scenarios that have a negative result may then be calculated, and that number may be used to calculate the percentage of default scenarios where a modeled default has occurred.

In step S34, a determination is made regarding whether the percentage determined percentage in step S32 satisfies a required implied financial strength rating for the SPRV. The required financial strength rating may be based on, for example, a reference default table provided by a relevant rating agency, the SPRV, or the protection buyer.

If the percentage of default scenarios determined in step S32 satisfies the required implied financial strength rating, in step S36, the maximum number of default scenarios required to achieve the required implied financial strength rating is determined. For example, if the average default rate required to achieve a required implied financial strength rating is 0.20%, a number of default scenarios is determined that achieves the 0.20% requirement (e.g., of 1,000 default scenarios, a maximum of 2 default scenarios are allowed under the required implied financial strength rating).

In step S38, a set of default scenarios is selected, where the number of default scenarios in the set is equal to or less than the maximum number of default scenarios determined in step S36, and where the set is made up of the default scenarios having the least negative values of all the default scenarios.

In step S40, collateralized reinsurance is provided to the protection buyer. In an exemplary embodiment, the reinsurance may be provided with the amount of covered losses capped based on the selected set of default scenarios. For the example, if the most negative default scenario within the selected set has a NAV of −$20 million, then the aggregate cap in the reinsurance or retrocession contract, which would be expressed in terms of a modeled percentile (e.g., 99.8^{th} percentile), would result in such modeled scenario generating tail risk to the Protection Buyer of $20 million. In an exemplary embodiment, the cap may be a “target cap”, meaning that, if the actual NAV at the end of the contractual period is less than the actual amount of losses, the reinsurer does not guarantee coverage up to the amount of the target cap, and if the actual NAV at the end of the contractual period is more than the actual amount of losses, the reinsurer is not obligated to pay the amount over the target cap. In other exemplary embodiments, the cap may be an absolute cap in that the reinsurer guarantees coverage of the losses up to a specified amount and may also be obligated to pay any excess amount.

In an exemplary embodiment of the invention, a required “true-up” amount may be determined that results in the number of default scenarios required to achieve the implied target financial strength rating. The present value of the “true-up” amount may be calculated using a relevant discount rate and this amount may be added to the up front hedging premium cost for the reinsurance contract. The total upfront cost of the reinsurance contract may be calculated by summing (i) the present value of the “true-up” amount, (ii) the present value of the put premium for the market hedge and the actuarial hedge, and (iii) the present value of the projected M&E fees for the tenor of the transaction.

FIG. 2 shows a sample portfolio of a Protection Buyer, including a subject risk portfolio, underwriting guidelines, market risk components and actuarial risk components. As explained previously, in various exemplary embodiments of the present invention, the data included in such a portfolio may be used by the reinsurer as input to estimate which investible indices (stand-alone or basket) would work as an efficient form of hedge for investment choices. The hedges may be calibrated to the portfolio to formulate the reinsurance product to be offered to the Protection Buyer.

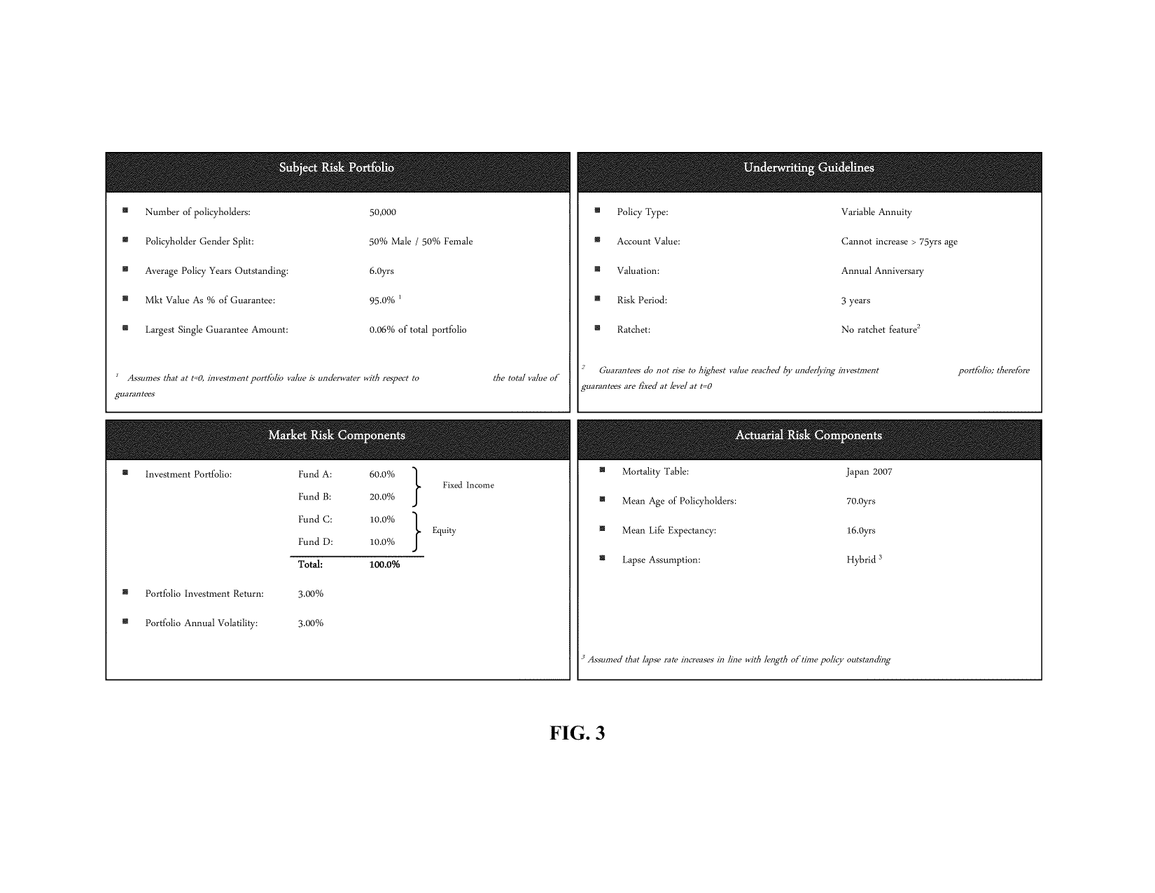

FIG. 3 shows exemplary charts that may be generated by the SPRV computer system as part of the scenario modeling used to formulate hedges to counter the risk associated with the Protection Buyer's variable annuity portfolio. Chart 20 shows the distribution of aggregate lapse rates over a three year period, which (where lapses in policies occur) would result in ‘windfall’ retention of any payout to the SPRV under the Market Hedges and Actuarial Hedges. Chart 22 shows the distribution of aggregate mortality rates over a three year period, which would result in payouts from the SPRV to the Protection Buyer. This data may be used by the SPRV to determine that hedging of 100% of the portfolio is not required over the three year period, since the ‘windfall’ retentions can be used to offset other losses that the SPRV may become obligated to pay in relation to policies which do not lapse.

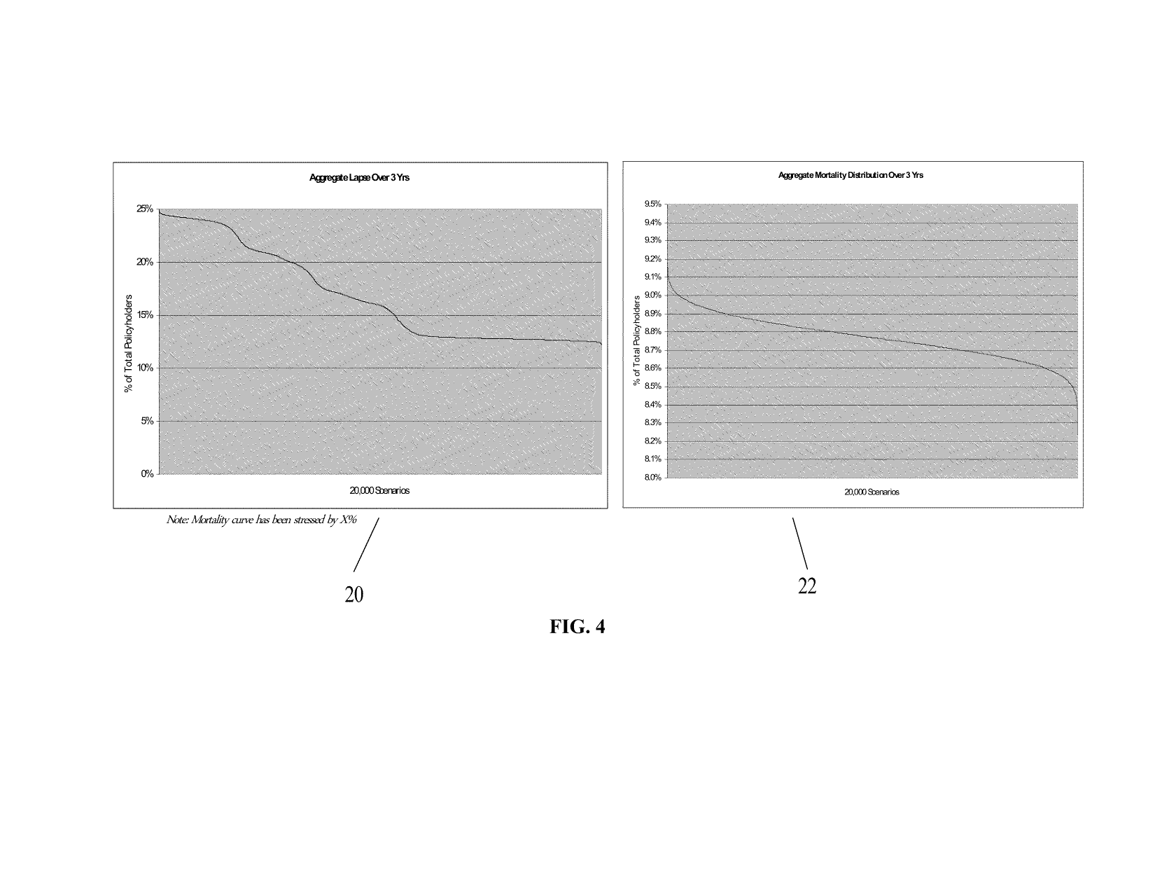

FIG. 4 shows another exemplary chart 24 that may be generated by the SPRV computer system as part of the scenario modeling. Chart 24 indicates the distribution of modeled net asset value (NAV) outcomes of the SPRV across all modeled scenarios. This data and result can be used to determine the modeled probability that the SPRV may not have sufficient resources to pay claims under the Reinsurance Contract. This probability would be fundamental to any assessment by rating agencies of the financial strength of the SPRV and/or the issuer credit rating of securities it may issue to hedge Market Risks and Actuarial Risks.

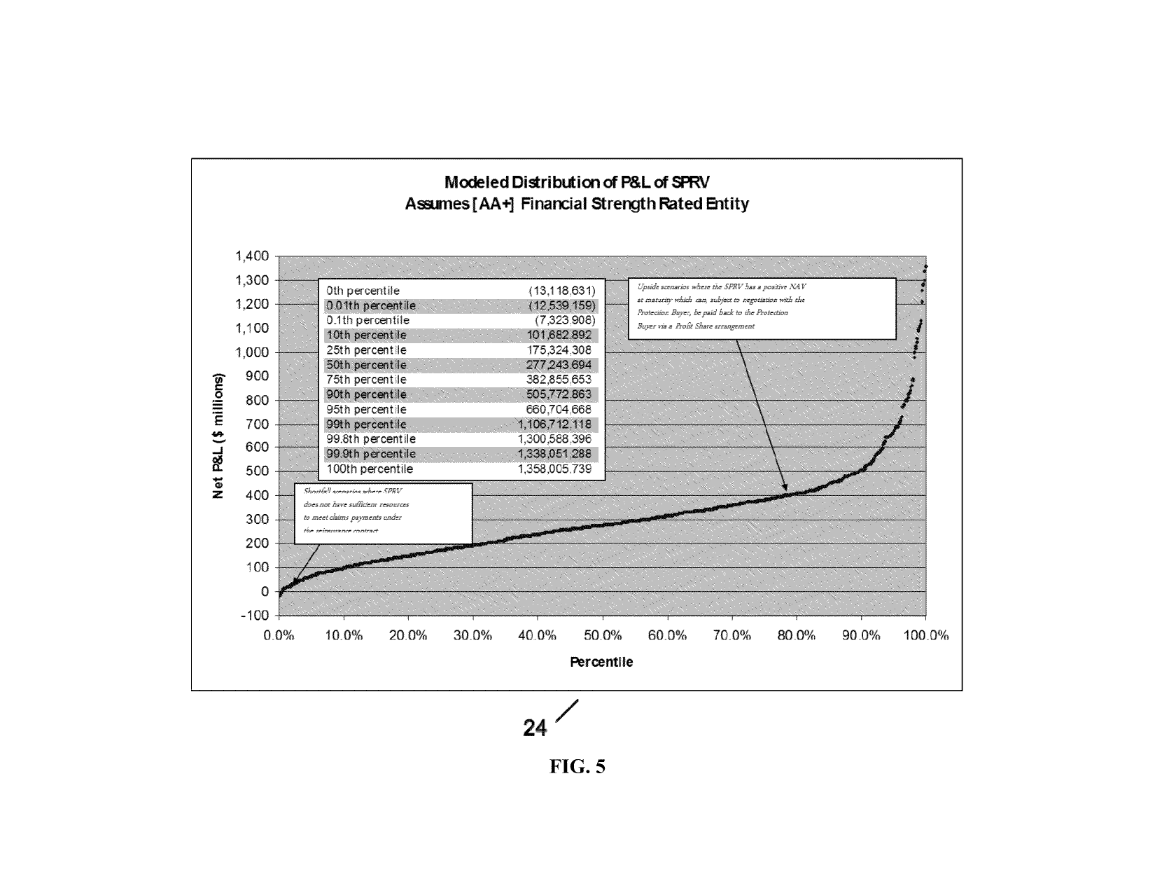

FIG. 5 shows an exemplary chart 26 demonstrating a particular scenario in which the SPRV may have insufficient capital to meet its obligations under the Reinsurance Contract. That is, there may be a hedge tracking error that is equivalent to the payout under the Market Hedge subtracted from the difference between the Account Value per policyholder at the time of mortality or maturity and the guarantee obligation of the Protection Buyer under the variable annuity contract with such policyholder. This tracking error may become evident at a trigger event, such as, for example, the death of the policyholder. In other scenarios, the hedge may over-perform (positive basis risk).

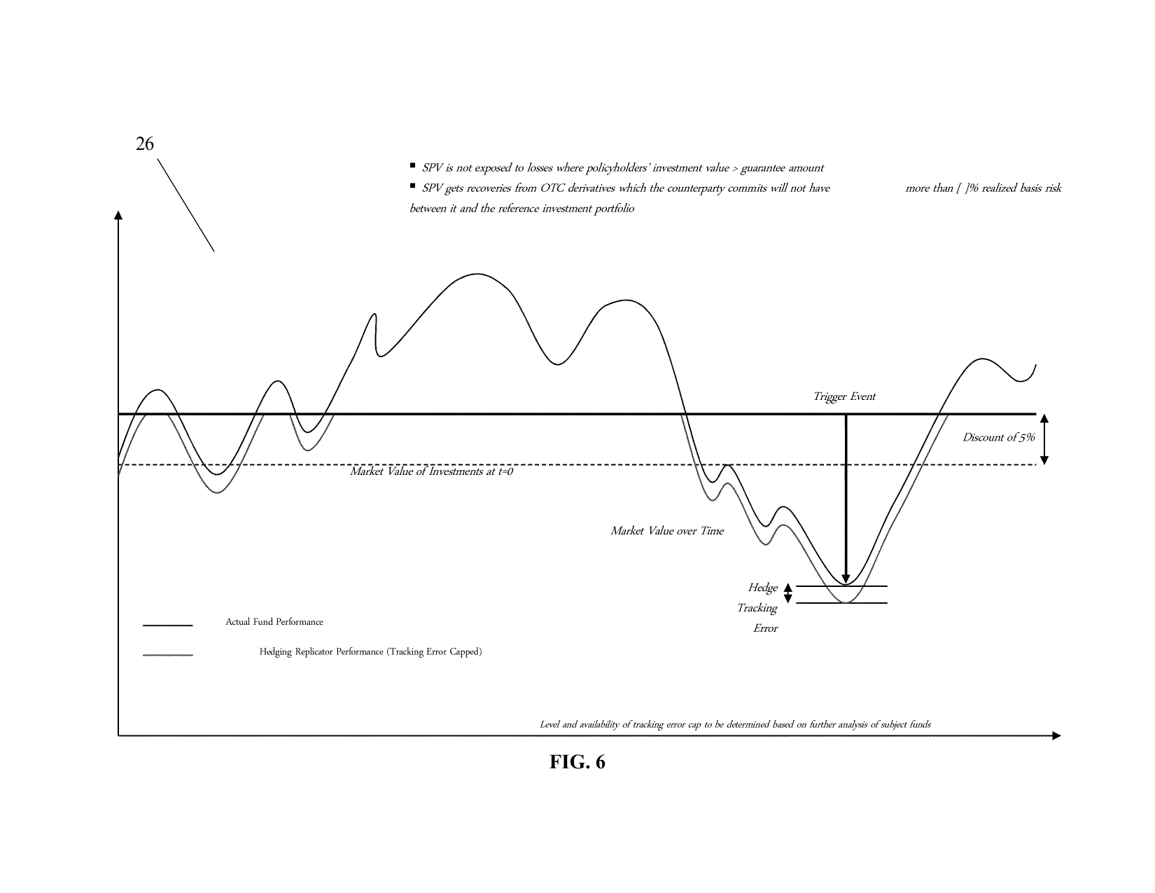

FIG. 6 shows a chart 28 of aggregate “true-up” of credits and debits for an exemplary transaction between the Protection Buyer and the reinsurer. Chart 28 shows in particular that the risk in a given transaction may be quantified by calculating the following: Total limit of exposure in the portfolio (i.e., sum of guarantees) PLUS Amount by which investment portfolio is underwater (t=0), if any, with respect to guarantee levels (if applicable) LESS Amount of guarantees which are not subject to a mortality or lapse trigger within the risk period PLUS Amount of payout due by SPRV in relation to early mortality related guarantees LESS Amount of guarantees which are subject to a lapse trigger within the risk period LESS Amounts received from derivative hedge with the financial entity PLUS Amounts relating to tracking error between actual underlying fund performance and derivative with financial entity LESS Capitalization of SPRV and actuarial/residual risk hedge with reinsurer.

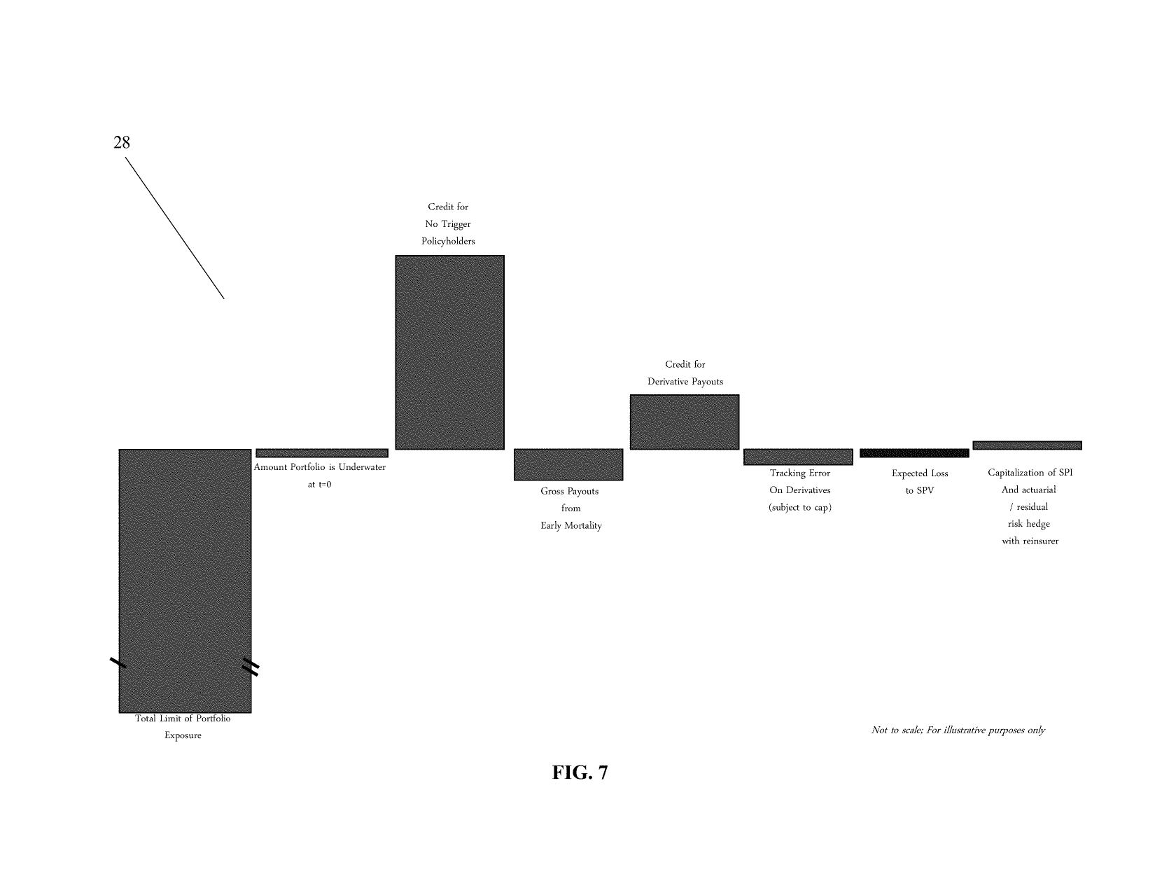

FIG. 7 is a table 30 showing an example of a single path outcome for a single policy assuming the Market Hedges are put options with a maturity of 3 years and there is no return on capital for cash buildup in SPRV over the transaction tenor.

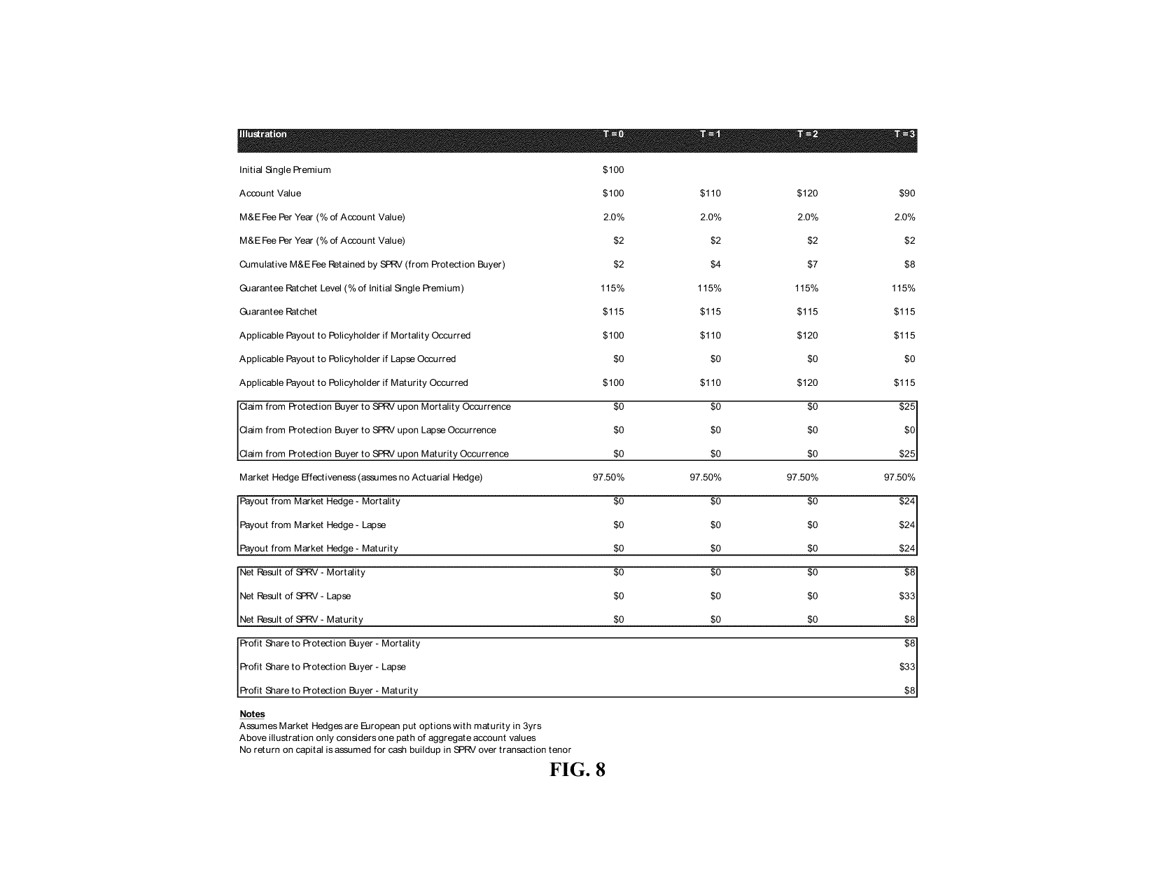

FIG. 8 provides the steps involved with carrying out a method of stochastic modeling of a transaction between a Protection Buyer and reinsurer according to an exemplary embodiment of the present invention. Iterations may occur between Steps 9 and 27 any number of times depending on the number of scenarios that are calculated. In the example shown, the number of scenarios is 10,000, although a greater or lesser number of scenarios may be calculated.

Now that embodiments of the present invention have been shown and described in detail, various modifications and improvements thereon will become readily apparent to those skilled in the art. Accordingly, the spirit and scope of the present invention is to be construed broadly not limited by the foregoing specification.

What is claimed is:

1. A method comprising the steps of:
1) obtaining, by one or more computers, first data related to a book of business of a protection buyer that provides insurance to one or more policyholders under one or more corresponding policies in force or to be written;
2) determining, using one or more computers, second data related to projected market performance of underlying assets of the book of business;
3) determining, using one or more computers, hedging data related to hedging, by a reinsurer, of losses incurred by the protection buyer in providing the insurance;
4) modeling, using one or more computers, a plurality of scenarios, each of the plurality of modeled scenarios comprising a projected net asset value of the reinsurer at the end of a modeled projection period based on the first data, the second data and the hedging data, the modeled projection period being divided into a plurality of time periods, each of the plurality of scenarios taking as input for each of the one or more policies and for each of the plurality of time periods a first random number used to determine mortality risk of the policy and a second random number used to determine behavioral risk of the policy;
5) calculating, using the one or more computers, a percentage of the modeled scenarios that are default scenarios in which the projected net asset value of the reinsurer is negative;
6) determining, using one or more computers, an implied financial strength rating of the reinsurer based on the calculated percentage of default scenarios;
7) determining, using one or more computers, whether the implied financial strength rating of the reinsurer satisfies a required implied financial strength rating;
8) if the financial strength rating of the reinsurer satisfies the required implied financial strength rating, determining, using one or more computers, a maximum number of the default scenarios that results in the determined implied financial strength rating of the reinsurer satisfying the required implied financial strength rating;
9) selecting, using one or more computers, a first set of the default scenarios, the first set of the default scenarios satisfying the following criteria:
i) the number of default scenarios in the first set is the maximum number of default scenarios; and
ii) the default scenarios in the first set have projected net asset values that are the least negative of all the default scenarios;
10) providing, using one or more computers, collateralized reinsurance to the protection buyer in an amount that is capped based on the first set of default scenarios.

2. The method of claim 1, wherein the insurance provided by the protection buyer is a variable annuity-based insurance.

3. The method of claim 2, wherein the insurance provided by the protection buyer is selected from one of the following types of insurance: Guaranteed Minimum Death Benefit, Guaranteed Minimum Acceptance Benefit and Guaranteed Minimum Income Benefit.

4. The method of claim 1, wherein the reinsurer is a Special Purpose Reinsurance Vehicle.

5. The method of claim 1, wherein the provided collateralized reinsurance is capped using a target cap.

6. The method of claim 1, further comprising the step of funding the reinsurer using premiums paid by the protection buyer.

7. The method of claim 1, wherein the step of determining hedging data comprising determining at least one of market hedging data or actuarial hedging data.

8. The method of claim 1, wherein the first data relates to information pertaining to each of the one or more policyholders.

9. The method of claim 8, wherein the information comprises one or more of the following types of information: policy number, product identifier, policy issuance date, policyholder age at date of policy issuance, policy term, gender of policyholder, premium paid per policy, details relating to guarantees provided to the policyholder, allocations made by policyholder into one or more investment funds, current account value of allocations made to the investment funds, details of all charges charged to the policyholder upfront and/or during the tenor of the policy, and details of investment funds available to policyholders.

10. The method of claim 1, wherein the step of modeling comprises identifying credits as one or more of the following: premiums received upfront and/or over time by the reinsurer from the protection buyer, payouts received by the reinsurer from the determined hedging data over time, and base capital invested into the reinsurer.

11. The method of claim 1, wherein the step of modeling comprises identifying debits as one or more of the following: hedging payments, operating costs, payments of losses under a reinsurance contract entered into by the reinsurer with the protection buyer, and payment of arranger fees.

12. The method of claim 1, wherein the second data is calculated using a Lognormal process or equivalent.

13. The method of claim 12, wherein the option pricing model is a Black-Scholes pricing model or derivation thereof.

14. The method of claim 12, wherein the option pricing model is a Binomial options pricing model or derivation thereof.

15. The method of claim 1, wherein the hedging data is determined using put options as the hedge.

16. The method of claim 1, wherein the hedging data is determined using over-the-counter derivative contracts as the hedge.

17. The method of claim 1, wherein the hedging data is determined using a proxy hedge.
